(19) United States
(12) Patent Application Publication
(10) Pub. No.: US 2026/0042219 A1
(43) Pub. Date: Feb. 12, 2026

(54) COMPUTER-IMPLEMENTED METHOD FOR GENERATING A SET OF PREDEFINED TEXT DESCRIPTIONS FOR A MACHINE LEARNING MODEL TRAINED FOR OPEN VOCABULARY OBJECT RECOGNITION

(71) Applicant: Robert Bosch GmbH, Stuttgart (DE)

(72) Inventor: Marlin Benedikt Schaefer, Hannover (DE)

(21) Appl. No.: 19/281,952

(22) Filed: Jul. 28, 2025

(30) Foreign Application Priority Data
Aug. 9, 2024 (DE) 10 2024 207 609.0

(51) Int. Cl. B25J 9/16; G06T 7/579; G06V 10/74; G06V 10/771; G06V 10/774; G06V 10/82

(52) U.S. Cl. CPC B25J 9/1697; G06T 7/579; G06V 10/761; G06V 10/771; G06V 10/774; G06V 10/82

(57) ABSTRACT

A method for generating predefined text descriptions for a trained open vocabulary machine learning model. The method includes: providing images and initial text descriptions, each associated with a region in a corresponding image and indicating what is shown in the region; ascertaining encoded dictionary text descriptions using a text encoder of the learning model; for each initial text description: ascertaining an encoded initial text description using the text encoder, selecting encoded dictionary text description(s) most similar to the encoded initial text description, inputting the image associated with the initial text description into the machine learning model and ascertaining a similarity between an output of the machine learning model and the region associated with the initial text description, and adding the text description with the greatest similarity to the set of predefined text descriptions.

### BACKGROUND INFORMATION

A trained open vocabulary machine learning model may be able to detect objects in images on which the machine learning model has not been trained. For this purpose, the machine learning model can use a dictionary with a plurality of dictionary text descriptions (as an open vocabulary). Clearly, the dictionary can contain dictionary text descriptions that refer to objects that were not visible in training images.

However, the accuracy with which the machine learning model recognizes these objects associated with the dictionary text descriptions can depend significantly on the terminology, so that putative synonyms can lead to significantly different recognition rates. For example, the recognition rate of the machine learning model in an image may be higher for the term “office chair” than for the term “chair.” The manual selection of suitable terminology (with a high recognition rate) is also called prompt engineering.

### SUMMARY

The present invention relates to methods for generating a set of predefined text descriptions for a machine learning model trained for open vocabulary object recognition, which enables automated selection of the suitable terminology. This eliminates the need for manual selection during prompt engineering, for example, which significantly reduces both costs (e.g. personnel costs for prompt engineering) and time expenditure. It also reduces the likelihood of spelling errors and the risk of performance degradation due to a limited vocabulary caused by the operator's language barriers.

Various aspects of the present invention relate to a computer-implemented method for generating a set of predefined text descriptions for a machine learning model (pre-)trained for open vocabulary object recognition such that, for each predefined text description, a region in an image input into the machine learning model is output if the region shows an object represented by the predefined text description, the method comprising: providing a plurality of images and a plurality of initial text descriptions, of which each initial text description is associated with a region (e.g., as a mask, bounding box, etc.) in a corresponding image of the plurality of images and indicates what is shown in the region; ascertaining a plurality of encoded dictionary text descriptions by generating an encoded dictionary text description for each dictionary text description of a plurality of dictionary text descriptions by means of a text encoder of the machine learning model, for each initial text description of the plurality of initial text descriptions: ascertaining an encoded initial text description by means of the text encoder, selecting (a predefined number of) one or more encoded dictionary text descriptions from the plurality of encoded dictionary text descriptions that are most similar to the encoded initial text description according to a first (semantic) similarity measure, for each text description of the initial text description and each dictionary text description that is associated with one of the (selected) one or more encoded dictionary text descriptions, as a predefined text description, inputting at least the image associated with the initial text description into the machine learning model and ascertaining a similarity between an output of the machine learning model and the region associated with the initial text description according to a second similarity measure, and adding the text description with the greatest (ascertained) similarity to the set of predefined text descriptions.

Various exemplary embodiments of the present invention are specified below.

Example 1 is the method for generating a set of predefined text descriptions as described above.

Example 2 is configured according to example 1, the region ascertained for the predefined text description by means of the machine learning model in the input image, and the region associated with the initial text description, being represented by means of a mask (e.g. segmentation mask) and/or a bounding box.

Example 3 is configured according to example 1 or 2, the first similarity measure comprising a cosine similarity and/or the second similarity measure comprising an intersection set over union.

Example 4 is configured according to one of examples 1 to 3, the one or more encoded dictionary text descriptions being selected according to a predefined number.

Example 5 is configured according to one of examples 1 to 4, inputting at least the image associated with the initial text description into the machine learning model comprising inputting each image of the plurality of images into the machine learning model and ascertaining the similarity across all images.

This can ensure that the text description is added to the set of predefined text descriptions for which the greatest similarity (e.g. a summed similarity) is ascertained in the entirety of all images of the plurality of images.

Example 6 is a data processing unit that is configured to carry out the method according to one of examples 1 to 5.

Example 7 is a method for controlling a (navigable) robot device, the method comprising: while the robot device navigates in its environment, generating a map of the environment by means of simultaneous localization and mapping (SLAM) and capturing images representing the environment; performing semantic object recognition for each captured image using the machine learning model with the set of predefined text descriptions generated according to one of examples 1 to 5; generating a semantic map of the environment by integrating a result of the semantic object recognition into the map of the environment; and controlling the robot device using the semantic map of the environment.

Example 8 is a control device comprising one or more than one processor configured to carry out the method according to example 7.

Example 9 is a robot device comprising: the control device according to example 8; and at least one imaging sensor configured to capture images of the environment of the robot device.

Example 10 is a computer program comprising commands that, when executed by a processor, cause the processor to carry out the method according to one of examples 1 to 5 or 7.

Example 11 is a computer-readable medium that stores commands that, when executed by a processor, cause the processor to carry out the method according to one of examples 1 to 5 or 7.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a robot device arrangement, according to various aspects of the present invention.

FIG. 2 shows a flow diagram of a method for generating a set of predefined text descriptions for a machine learning model trained for open vocabulary object recognition, according to various aspects of the present invention.

FIG. 3 shows a schematic flow diagram of the method for generating the set of predefined text descriptions, according to various aspects of the present invention.

FIG. 4 shows the use of the method to generate a semantic map of an environment of the robot device, according to various aspects of the present invention.

### DETAILED DESCRIPTION OF EXAMPLE EMBODIMENTS

The following detailed description relates to the accompanying drawings, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

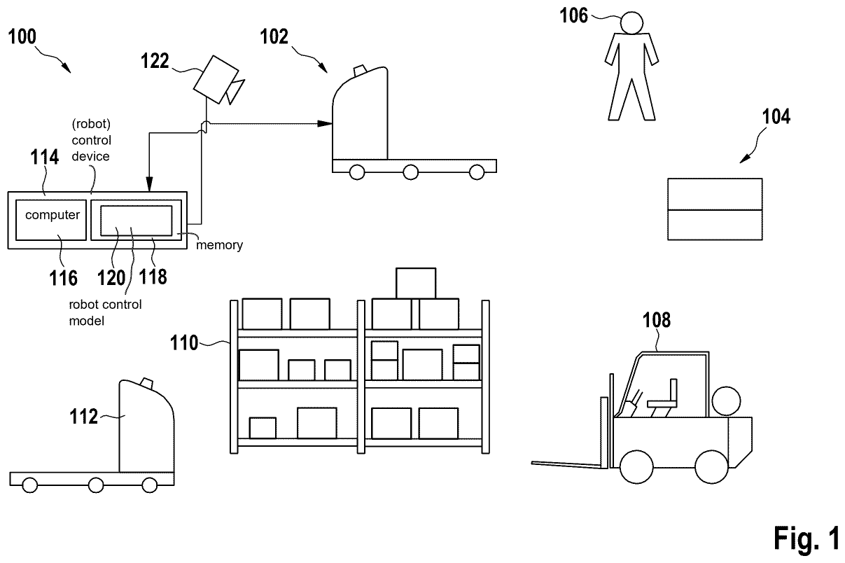

FIG. 1 shows a robot device assembly 100 according to various aspects. The robot device assembly 100 may include a robot device 102 (robot for short). The robot device 102 shown in FIG. 1 and described below by way of example represents a robot device by way of example, for illustrative purposes, and may, for example, comprise a transport robot for transporting objects (e.g. goods) 104 within its (dynamic) environment, such as a factory or a warehouse. The robot device 102 may, for example, be an Active Shuttle from Bosch Rexroth. The robot device 102 may be a floor-mounted robot. For this purpose, the robot device 102 may, for example, comprise wheels or any other suitable component (e.g. crawler tracks, support legs, etc.). It is noted that this robot device is illustrative and can generally be any type of computer-controlled device capable of navigating (e.g. autonomously or at least semi-autonomously) in its environment, such as a household robot (e.g. a cleaning robot), an at least partially automated vehicle, etc.

For illustration, FIG. 1 shows a warehouse as a (dynamic) environment of the robot device 102, which may include static objects, such as the objects 104, one or more shelves 110, etc., and/or dynamic objects, such as one or more other robot devices 112, one or more forklifts 108, one or more people (e.g. workers) 106, etc.

In order to control the robot device 102, the robot device arrangement 100 may comprise a (robot) control device 114 which is configured to realize the interaction with the environment according to a control program. In some aspects, the robot device 102 may include the control device 114. In other aspects, the robot device arrangement 100 may include a (central) control device 114 that may be configured to control the robot device 102 and optionally one or more further robot devices (e.g. including the further robot device 112). In still other aspects, the robot device 102 may include a control device that implements a portion of the control device 114, and another (central) control device may implement another portion of the control device 114 described herein.

The term “control device” (also referred to as “controller”) can be understood as any type of logical implementation unit that can include, for example, a circuit and/or a processor that is capable of executing software, firmware, or a combination thereof stored in a storage medium, and can issue the instructions, e.g. to an actuator in the present example. The control device can be configured, for example, by program code (e.g. software) to control the operation of a system, in the present example a robot.

In the present example, the control device 114 may include a computer 116 and a memory 118 that stores the code and data on the basis of which the computer 116 controls the robot device 102. According to various embodiments, the control device 114 may control the robot device 102 on the basis of a robot control model 120 stored in the memory 118.

In order to navigate the robot device 102 in its (dynamic) environment, the control device 114 can use sensor data representing the environment of the robot device 102. For example, the sensor data may include images of the environment of the robot device 102 provided by one or more imaging sensors 122. At least one of the one or more imaging sensors 122 may be attached to the robot device 102 and/or at least one of the one or more imaging sensors 122 may be separate from the robot device 102 (e.g. to allow a view for observing more than one robot device 102).

An imaging sensor as used herein may be, for example, a camera (e.g. a standard camera, a digital camera, an infrared camera, a stereo camera, etc.), a radar sensor, a LIDAR sensor, an ultrasonic sensor, etc. Therefore, an image can be an RGB image, an RGB-D image, or a depth image (also called a D-image). A depth image described herein may be any type of image that includes depth information. A depth image can contain 3-dimensional information about one or more objects. For example, a depth image described herein may include a point cloud provided by a LIDAR sensor and/or a radar sensor. A depth image can, for example, be an image with depth information provided by a LIDAR sensor.

It is understood that the one or more imaging sensors 122 are examples and that the robot device arrangement 100 may include any other type of one or more perception sensors.

The control device 114 may be configured to control the robot device 102 on the basis of an output of the control model 120 in response to the input of at least one image into the control model 120.

In order to detect objects in the environment of the robot device 102 (e.g. to detect the objects 104, the one or more people 106, the one or more forklifts 108, the one or more other robot devices 112, etc.), the control model 120 may include a machine learning model trained for open vocabulary object recognition.

A machine learning model trained for open vocabulary object recognition may be able to recognize objects on which the machine learning model was not explicitly trained. For this purpose, the machine learning model can use a set of predefined text descriptions. As explained herein, the accuracy with which the machine learning model detects objects may depend on the terminology of the text descriptions in the set of predefined text descriptions.

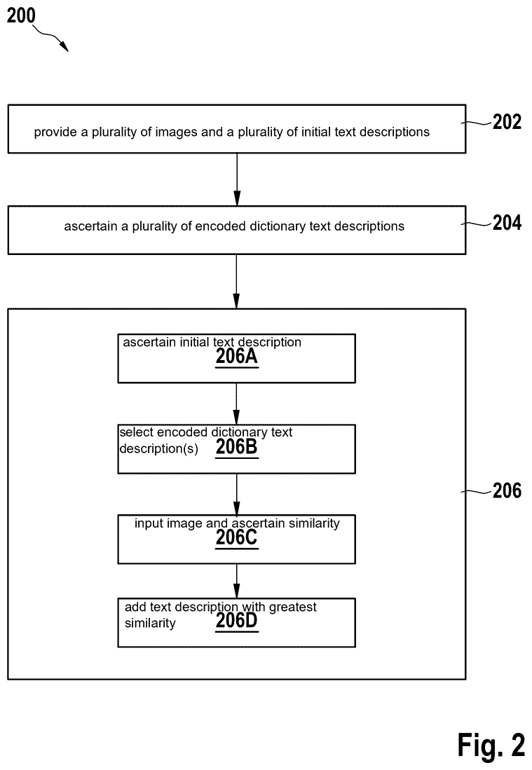

FIG. 2 shows a flow diagram of a (computer-implemented) method 200 for generating a set of predefined text descriptions for a machine learning model trained for open vocabulary object recognition, according to various aspects.

The machine learning model may have been trained to output a region in an image input to the machine learning model for each predefined text description if the region shows an object represented by the predefined text description. For example, a predefined text description may be the term “chair” and the machine learning model may recognize, in an image input into it, a region of the image if it shows a “chair.”

The method 200 enables automated ascertainment of the set of predefined text descriptions.

The method 200 may include (in 202) providing a plurality of images and a plurality of initial text descriptions. Each initial text description of the plurality of initial text descriptions may be associated with a region (e.g. as a mask, bounding box, etc.) in an associated image of the plurality of images, and may indicate what is shown in the region. For example, an image may show a chair, which is represented by an associated region (e.g. a mask or bounding box) in the image, and the associated initial text description may be “chair.” The object recognition described herein may also include image segmentation.

The method 200 may include (in 204) ascertaining a plurality of encoded dictionary text descriptions by generating an encoded dictionary text description for each dictionary text description of a plurality of dictionary text descriptions by means of a text encoder of the machine learning model.

The method 200 may comprise (in 206), for each initial text description of the plurality of initial text descriptions:
ascertaining an encoded initial text description by means of the text encoder (in 206A);
selecting (a predefined number of) one or more encoded dictionary text descriptions from the plurality of encoded dictionary text descriptions that are most similar to the encoded initial text description according to a first (semantic) similarity measure (in 206B);
for each text description of the initial text description and each dictionary text description associated with one of the (selected) one or more encoded dictionary text descriptions as a predefined text description, inputting at least the image associated with the initial text description into the machine learning model and ascertaining a similarity between an output of the machine learning model and the region associated with the initial text description according to a second similarity measure (in 206C); and
adding the text description with the greatest (ascertained) similarity to the set of predefined text descriptions.

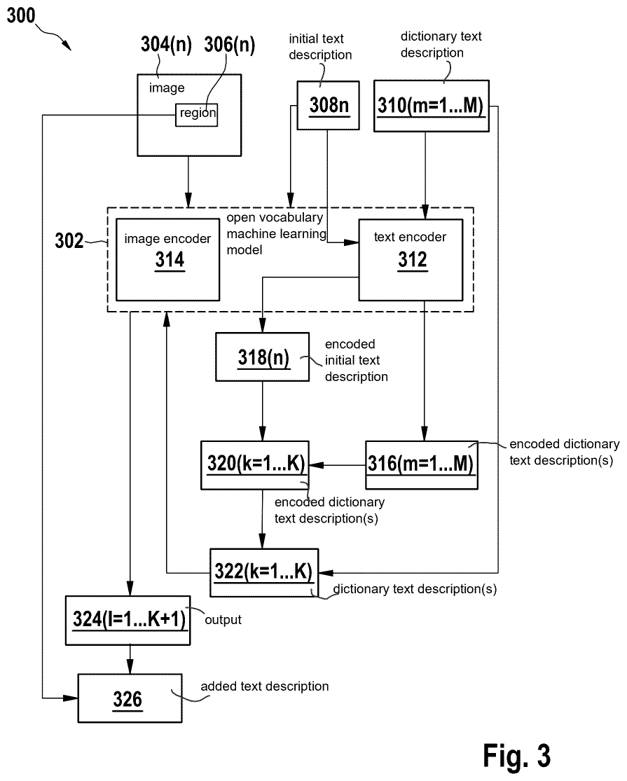

Various aspects of the method 200 are described in more detail below. FIG. 3 shows a schematic flow diagram 300 with various aspects of the method 200.

An open vocabulary machine learning model 302 may generally include a text encoder 312 and an image encoder 314. The image encoder 314 may be configured to encode an input image (i.e. generate an encoded image, also referred to as a latent representation of the image). The text encoder 312 may be configured to encode an input text description (i.e. to generate an encoded text description, also referred to as a latent representation of the text description). The text encoder 312 can be trained to map two texts with similar semantic meaning (e.g. synonyms) to two latent representations that have a high similarity according to a predefined similarity measure.

The plurality of images 304(n=1 . . . N) provided in 202 may include a number N of images (where N is any integer greater than or equal to one). Here, an initial text description 308(n) can be associated with a region (e.g. as a mask, bounding box, etc.) 306(n) in an image 304(n).

Furthermore, the plurality of dictionary text descriptions 310(m=1 . . . M) may be provided. Here, “M” can be any integer greater than or equal to two. According to various aspects, M may be greater than or equal to 100, e.g. greater than or equal to 1000, e.g. greater than or equal to 10000.

In 204, for each dictionary text description 310(m) of the plurality of dictionary text descriptions 310(m=1 . . . M), an associated encoded dictionary text description 316(m) may be generated by inputting the dictionary text description 310(m) into the text encoder 312. In this way, the plurality of encoded dictionary text descriptions 316(m=1 . . . M) can be generated.

In 206A, the initial text description 308(n) may be input into the text encoder 312 to ascertain the encoded initial text description 318(n).

In 206B, for each encoded dictionary text description 316(m) of the plurality of encoded dictionary text descriptions 316(m=1 . . . M), a similarity (e.g. represented by a similarity value) between the encoded dictionary text description 316(m) and the encoded initial text description 318(n) may be ascertained according to a first (semantic) similarity measure. The first (semantic) similarity measure can, for example, be a cosine similarity. It is understood that the cosine similarity is by way of example and any other similarity measure (e.g. a similarity metric, e.g. a distance metric) may be used, as long as it corresponds to the distance measure used by the text encoder. From the M encoded dictionary text descriptions 316(m=1 . . . M), a predefined number K of one or more encoded dictionary text descriptions 320(k=1 . . . K) can then be selected which are most similar to the encoded initial text description 318(n). “K” can be an integer greater than or equal to one. In this case, the one or more dictionary text descriptions 322(k=1 . . . K) may correspond to the dictionary text descriptions from the plurality of dictionary text descriptions 310(m=1 . . . M) on the basis of which the one or more encoded dictionary text descriptions 320(k=1 . . . K) were ascertained.

Selecting the K most similar dictionary text descriptions can reduce the computational effort of subsequent object recognition.

In 206C, a recognition rate of the recognition of at least the object shown in the region 306(n) can then be ascertained for the initial text description 308(n) and for each dictionary text description 322(k) of the one or more dictionary text descriptions 322(k=1 . . . K). In some aspects, for the initial text description 318(n) and for each dictionary text description 322(k) of the one or more dictionary text descriptions 322(k=1 . . . K), a particular recognition rate may be ascertained for each image 304(n) of the plurality of images 304(n=1 . . . N). For the purpose of illustration and ease of understanding, various explanations only refer to the object recognition for the image 304(n) associated with the initial text description 308(n).

Clearly, the initial text description 318(n) and each dictionary text description 322(k) of the one or more dictionary text descriptions 322(k=1 . . . K) can be regarded as a predefined text description on the basis of which the object recognition is carried out by means of the machine learning model 302. The output 324(l=1 . . . K+1) may indicate a corresponding region in the image 304(n) for each text description of the initial text description 318(n) and each dictionary text description 322(k) if the object represented by the text description was recognized in the image 304(n) by means of the machine learning model 302.

In order to ascertain the recognition rate, the particular output 324(l) for each of the K+1 text descriptions can then be compared with the region 306(n). For this purpose, for example a similarity between these can be ascertained according to a second similarity measure. For example, the region 306(n) may be a (e.g., segmentation) mask or a bounding box, and the region output by the machine learning model 302 may also be a mask or a bounding box. In this case, the second similarity measure can, for example, be an intersection set over a union of the regions to be compared. It is understood that if the object is not recognized for one of the text descriptions, no region is output and thus there is no intersection set at all.

In 206D, the text description 326 with the greatest (ascertained) similarity can then be added to the set of predefined text descriptions. This added text description 326 can therefore be either the initial text description 308(n) or one of the dictionary text descriptions of the plurality of encoded dictionary text descriptions 316(m=1 . . . M).

In this way, a text description 326 can be ascertained in an automated manner, for which description the trained machine learning model 302 has a high recognition rate of the associated object.

By performing 206A to 206D for all initial text descriptions 308(n=1 . . . N), the set of predefined text descriptions is generated. Ascertaining the set of predefined text descriptions after training the machine learning model can be considered hyperparameter optimization.

The method 200 can be used to ascertain the set of predefined text descriptions for a variety of applications in object recognition. For example, the robot device 102 may be configured for object recognition. Optionally, the method 200 may be used during operation of the robot device 102. For example, the machine learning model 302 may receive feedback (e.g. from an operator of the robot device 102) for an object shown in an image, because it was previously detected incorrectly, for example. The feedback may include the initial text description of the object and the region of the image showing the object may be marked (e.g. by means of a bounding box, a mask, etc.). Then, for this image and the associated initial text description, the method 200 can be performed in order to add an (optimized) text description to the set of predefined text descriptions. Clearly, the method 200 allows online hyperparameter optimization.

A method for controlling a robot (e.g. the robot device 102) may include capturing an image (e.g. using one or more imaging sensors described herein) showing one or more objects (in the environment of robot device 102). The method for controlling the robot may include inputting the image into the machine learning model 302 with the set of predefined text descriptions as an open vocabulary, in order to recognize the one or more objects, and may then include controlling the robot taking into account the recognized one or more objects (e.g. navigating the robot device 102 in its (dynamic) environment). Object recognition can, for example, be semantic and/or panoptic object recognition.

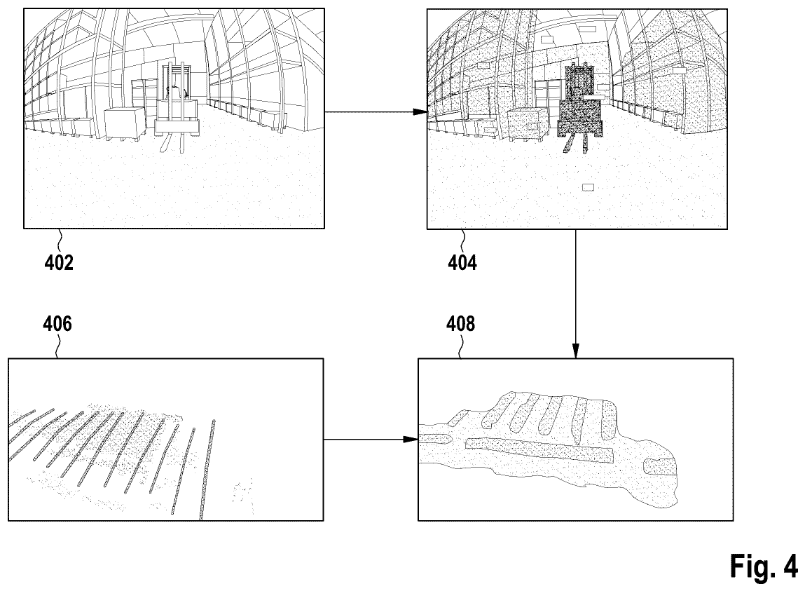

With reference to FIG. 4, the robot device 102 can perform object recognition in the image 402 captured at a specific time by means of the machine learning model 302 with the set of predefined text descriptions as an open vocabulary, in order to generate a (e.g. semantic or panoptic) segmentation image 404 on the basis of the object recognition. The machine learning model 302 can be used for semantic object recognition. This can be done for multiple images which are captured as the robot device 102 navigates its environment. Furthermore, the robot device 102 (while navigating in its environment) can generate a map 406 of the environment by means of simultaneous localization and mapping (SLAM). The map 406 may enable the robot device 102 to navigate in the environment.

According to various aspects, a semantic map 408 of the environment may then be generated on the basis of one or more segmentation images 404 and the map 406 of the environment (by integrating a result of the semantic object recognition into the map 406 of the environment). The robot device 102 can then be controlled using this semantic map 408 of the environment. In this context, the use of an open vocabulary machine learning model generally allows for the addition of new object classes (during operation), and the method 200 allows for the optimization of the text description for such a new object class. This means that it is not necessary to replace the semantic object recognition model, but rather this can be adapted during operation.

1-10. (canceled)

11. A computer-implemented method for generating a set of predefined text descriptions for a machine learning model trained for open vocabulary object recognition such that, for each predefined text description, a region in an image input into the machine learning model is output when the region shows an object represented by the predefined text description, the method comprising the following steps:
providing a plurality of images and a plurality of initial text descriptions, each of the initial text descriptions is associated with a region in a corresponding image of the plurality of images and indicates what is shown in the region;
ascertaining a plurality of encoded dictionary text descriptions by generating an encoded dictionary text description for each dictionary text description of a plurality of dictionary text descriptions using a text encoder of the machine learning model;
for each initial text description of the plurality of initial text descriptions:
ascertaining an encoded initial text description using the text encoder,
selecting one or more encoded dictionary text descriptions from the plurality of encoded dictionary text descriptions that are most similar to the encoded initial text description according to a first similarity measure,
for each text description of the initial text descriptions and each dictionary text description associated with one of the one or more encoded dictionary text descriptions as a predefined text description, inputting at least the image associated with the initial text description into the machine learning model and ascertaining a similarity between an output of the machine learning model and the region associated with the initial text description according to a second similarity measure, and
adding the text description with the greatest similarity according to the second similarity measure to the set of predefined text descriptions.

12. The method according to claim 11, wherein the region ascertained for the predefined text description using the machine learning model in the input image, and the region associated with the initial text description, are represented using a mask and/or a bounding box.

13. The method according to claim 11, wherein the first similarity measure has a cosine similarity, and/or the second similarity measure has an intersection set over union.

14. The method according to claim 11, wherein the inputting of the at least the image associated with the initial text description into the machine learning model includes inputting each image of the plurality of images into the machine learning model and ascertaining a similarity across all images.

15. A method for controlling a robot device, the method comprising the following steps:
generating, while the robot device navigates in an environment of the robot, a map of the environment using simultaneous localization and mapping, and capturing images representing the environment;
performing semantic object recognition for each captured image using a machine learning model with a set of predefined text descriptions, the machine learning model being trained for open vocabulary object recognition such that, for each predefined text description, a region in an image input into the machine learning model is output when the region shows an object represented by the predefined text description, the set of predefined text descriptions being generated by:
providing a plurality of images and a plurality of initial text descriptions, each of the initial text descriptions is associated with a region in a corresponding image of the plurality of images and indicates what is shown in the region;
ascertaining a plurality of encoded dictionary text descriptions by generating an encoded dictionary text description for each dictionary text description of a plurality of dictionary text descriptions using a text encoder of the machine learning model;
for each initial text description of the plurality of initial text descriptions:
ascertaining an encoded initial text description using the text encoder,
selecting one or more encoded dictionary text descriptions from the plurality of encoded dictionary text descriptions that are most similar to the encoded initial text description according to a first similarity measure,
for each text description of the initial text descriptions and each dictionary text description associated with one of the one or more encoded dictionary text descriptions as a predefined text description, inputting at least the image associated with the initial text description into the machine learning model and ascertaining a similarity between an output of the machine learning model and the region associated with the initial text description according to a second similarity measure, and
adding the text description with the greatest similarity according to the second similarity measure to the set of predefined text descriptions;
generating a semantic map of the environment by integrating a result of the semantic object recognition into the map of the environment; and
controlling the robot device using the semantic map of the environment.

16. A data processing unit configured to generate a set of predefined text descriptions for a machine learning model trained for open vocabulary object recognition such that, for each predefined text description, a region in an image input into the machine learning model is output when the region shows an object represented by the predefined text description, the data processing unit being configured to perform the following steps:
providing a plurality of images and a plurality of initial text descriptions, each of the initial text descriptions is associated with a region in a corresponding image of the plurality of images and indicates what is shown in the region;
ascertaining a plurality of encoded dictionary text descriptions by generating an encoded dictionary text description for each dictionary text description of a plurality of dictionary text descriptions using a text encoder of the machine learning model;
for each initial text description of the plurality of initial text descriptions:
ascertaining an encoded initial text description using the text encoder,
selecting one or more encoded dictionary text descriptions from the plurality of encoded dictionary text descriptions that are most similar to the encoded initial text description according to a first similarity measure,
for each text description of the initial text descriptions and each dictionary text description associated with one of the one or more encoded dictionary text descriptions as a predefined text description, inputting at least the image associated with the initial text description into the machine learning model and ascertaining a similarity between an output of the machine learning model and the region associated with the initial text description according to a second similarity measure, and
adding the text description with the greatest similarity according to the second similarity measure to the set of predefined text descriptions.

17. A control device, comprising:
one or more processor configured to control a robot device, the one or more preocessors being configured to perform the following steps:
generating, while the robot device navigates in an environment of the robot, a map of the environment using simultaneous localization and mapping, and capturing images representing the environment;
performing semantic object recognition for each captured image using a machine learning model with a set of predefined text descriptions, the machine learning model being trained for open vocabulary object recognition such that, for each predefined text description, a region in an image input into the machine learning model is output when the region shows an object represented by the predefined text description, the set of predefined text descriptions being generated by:
providing a plurality of images and a plurality of initial text descriptions, each of the initial text descriptions is associated with a region in a corresponding image of the plurality of images and indicates what is shown in the region;
ascertaining a plurality of encoded dictionary text descriptions by generating an encoded dictionary text description for each dictionary text description of a plurality of dictionary text descriptions using a text encoder of the machine learning model;
for each initial text description of the plurality of initial text descriptions:
ascertaining an encoded initial text description using the text encoder,
selecting one or more encoded dictionary text descriptions from the plurality of encoded dictionary text descriptions that are most similar to the encoded initial text description according to a first similarity measure,
for each text description of the initial text descriptions and each dictionary text description associated with one of the one or more encoded dictionary text descriptions as a predefined text description, inputting at least the image associated with the initial text description into the machine learning model and ascertaining a similarity between an output of the machine learning model and the region associated with the initial text description according to a second similarity measure, and
adding the text description with the greatest similarity according to the second similarity measure to the set of predefined text descriptions;
generating a semantic map of the environment by integrating a result of the semantic object recognition into the map of the environment; and
controlling the robot device using the semantic map of the environment.

18. A robot device, comprising:
a control device including one or more processor configured to control a robot device, the one or more preocessors being configured to perform the following steps:
generating, while the robot device navigates in an environment of the robot, a map of the environment using simultaneous localization and mapping, and capturing images representing the environment;
performing semantic object recognition for each captured image using a machine learning model with a set of predefined text descriptions, the machine learning model being trained for open vocabulary object recognition such that, for each predefined text description, a region in an image input into the machine learning model is output when the region shows an object represented by the predefined text description, the set of predefined text descriptions being generated by:
providing a plurality of images and a plurality of initial text descriptions, each of the initial text descriptions is associated with a region in a corresponding image of the plurality of images and indicates what is shown in the region;
ascertaining a plurality of encoded dictionary text descriptions by generating an encoded dictionary text description for each dictionary text description of a plurality of dictionary text descriptions using a text encoder of the machine learning model;
for each initial text description of the plurality of initial text descriptions:
ascertaining an encoded initial text description using the text encoder,
selecting one or more encoded dictionary text descriptions from the plurality of encoded dictionary text descriptions that are most similar to the encoded initial text description according to a first similarity measure,
for each text description of the initial text descriptions and each dictionary text description associated with one of the one or more encoded dictionary text descriptions as a predefined text description, inputting at least the image associated with the initial text description into the machine learning model and ascertaining a similarity between an output of the machine learning model and the region associated with the initial text description according to a second similarity measure, and
adding the text description with the greatest similarity according to the second similarity measure to the set of predefined text descriptions;
generating a semantic map of the environment by integrating a result of the semantic object recognition into the map of the environment, and
controlling the robot device using the semantic map of the environment; and
at least one imaging sensor configured to capture the images of the environment of the robot device.

19. A non-transitory computer-readable medium on which are stored commands for generating a set of predefined text descriptions for a machine learning model trained for open vocabulary object recognition such that, for each predefined text description, a region in an image input into the machine learning model is output when the region shows an object represented by the predefined text description, the commands, when executed by a computer, causing the computer to perform the following steps:
providing a plurality of images and a plurality of initial text descriptions, each of the initial text descriptions is associated with a region in a corresponding image of the plurality of images and indicates what is shown in the region;
ascertaining a plurality of encoded dictionary text descriptions by generating an encoded dictionary text description for each dictionary text description of a plurality of dictionary text descriptions using a text encoder of the machine learning model;
for each initial text description of the plurality of initial text descriptions:
ascertaining an encoded initial text description using the text encoder,
selecting one or more encoded dictionary text descriptions from the plurality of encoded dictionary text descriptions that are most similar to the encoded initial text description according to a first similarity measure,
for each text description of the initial text descriptions and each dictionary text description associated with one of the one or more encoded dictionary text descriptions as a predefined text description, inputting at least the image associated with the initial text description into the machine learning model and ascertaining a similarity between an output of the machine learning model and the region associated with the initial text description according to a second similarity measure, and
adding the text description with the greatest similarity according to the second similarity measure to the set of predefined text descriptions.
